(19) United States
(12) Patent Application Publication
(10) Pub. No.: US 2004/0123093 A1
(43) Pub. Date: Jun. 24, 2004

(54) Method and apparatus for loading BIOS and option ROM's from alternate locations

(76) Inventors: Michael A. Rothman, Gig Harbor, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/326,467

(22) Filed: Dec. 20, 2002

(51) Int. Cl. G06F 9/445

(52) U.S. Cl. 713/2

(57) ABSTRACT

A method and apparatus for loading BIOS (Basic Input/Output System) and option ROM's from alternate locations is presented. In this regard, a micro-BIOS is introduced to be executed in response to receipt of an indication associated with an initialization event, to identify remote locations of extended BIOS elements to execute in booting the electronic appliance, and to execute the extended BIOS elements to boot the electronic appliance.

### TECHNICAL FIELD

Embodiments of the present invention generally relate to the field of electronic appliances and, more particularly, to a method and apparatus for loading BIOS and option ROM's from alternate locations.

### BACKGROUND

Some electronic appliances utilize dedicated non-volatile memory devices to store content needed by the electronic appliance to power-on (colloquially referred to as boot) and/or to function. One example of this kind of dedicated memory device is flash memory, which retains its contents when there is no power applied to it. One example of the kind of content stored in flash memory is basic input/output system software (BIOS). Some electronic appliances, including computing devices, contain peripherals that also contain flash memory and a type of BIOS known as an option read only memory (option ROM), which allows the peripheral to interact properly with the main BIOS of the electronic appliance.

The BIOS of an electronic appliance typically initializes most hardware devices within the electronic appliance after a power-on event, for example the pressing of the power button. The BIOS then typically hands over control of the electronic appliance to an operating system, for example an operating system from Microsoft Corporation, which allows a user to interact with the electronic appliance.

### BRIEF DESCRIPTION OF THE DRAWINGS

Embodiments of the present invention is illustrated by way of example, and not by way of limitation, in the figures of the accompanying drawings in which like reference numerals refer to similar elements and in which:

FIG. 1 is a block diagram of an example electronic appliance suitable for implementing the micro-BIOS, in accordance with one example embodiment of the invention;

FIG. 2 is a block diagram of an example micro-BIOS architecture, in accordance with one example embodiment of the invention;

FIG. 3 is a graphical illustration of an example data structure suitable for use in accordance with the micro-BIOS, in accordance with one example embodiment of the invention;

FIG. 4 is a flow chart of an example method for booting an electronic appliance, in accordance with one example embodiment of the invention; and

FIG. 5 is a flow chart of an example method for implementing a micro-BIOS, in accordance with one example embodiment of the invention.

### DETAILED DESCRIPTION

Embodiments of the present invention are generally directed to a method and related apparatus for loading BIOS and option ROM's from alternate locations. In this regard, a micro basic input/output system (micro-BIOS) is presented which employs an innovative method to reduce the required size of certain storage devices to boot the electronic appliance. Those skilled in the art will appreciate, from the description to follow, that the method enabled by the micro-BIOS facilitates cost savings by moving BIOS elements and option read-only-memory (ROM) elements from dedicated storage devices to other storage devices that do not increase the cost of the electronic appliance, thereby reducing the need for dedicated storage devices to store BIOS and option ROM elements.

In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments.

FIG. 1 is a block diagram of an example electronic appliance suitable for implementing the micro-BIOS, in accordance with one example embodiment of the invention. Electronic appliance 100 is intended to represent any of a number of devices including, but not limited to: a computer, a communication appliance, a network device, a multimedia device, a household appliance, etc. Electronic appliance 100 includes controller(s) 102, bus 104, system memory 106, display interface 108, video display interface 110, input/output interface(s) 112, keyboard/pointing device(s) 114, network interface 116, fixed storage device(s) 118, removable storage device(s) 120, RAM 122, application(s) 124, data 126, ROM 128, and micro-BIOS 130 coupled as shown in FIG. 1. Micro-BIOS 130 as described more fully hereinafter, may well be used in electronic appliances of greater or lesser complexity than that depicted in FIG. 1. Also, the innovative detection and configuration attributes of micro-BIOS 130 as described more fully hereinafter may well be embodied in a combination of hardware and software.

Electronic appliance 100 includes controller(s) 102 for processing information. An example of a controller 102 is a microprocessor. As used herein, controller(s) 102 control the overall operation of electronic appliance 100. Electronic appliance 100 further includes bus 104, which is coupled with controller 102, to facilitate the transfer of data within electronic appliance 100.

System memory 106 comprises random access memory (RAM) 122 that is coupled with bus 104 for storing information and instructions to be executed by controller 102. System memory 106 also can be used for storing temporary variables or other intermediate information during execution of instructions by controller 102. Typically, applications 124 and data 126 are stored in RAM 122 when they have been or will soon be used by controller 102, because of the quick access capabilities of RAM 122. RAM 122 may comprise any of a number of dynamic random access memory (DRAM) technologies available. In one embodiment, RAM 122 comprises Direct Rambus™ DRAM (RDRAM). In an alternate embodiment, RAM 122 comprises double data rate synchronous DRAM (DDR SDRAM). System memory 106 typically has to be initialized on every boot, because it is possible for a user to add memory modules to and/or remove memory modules from system memory 106 prior to powering on electronic appliance 100.

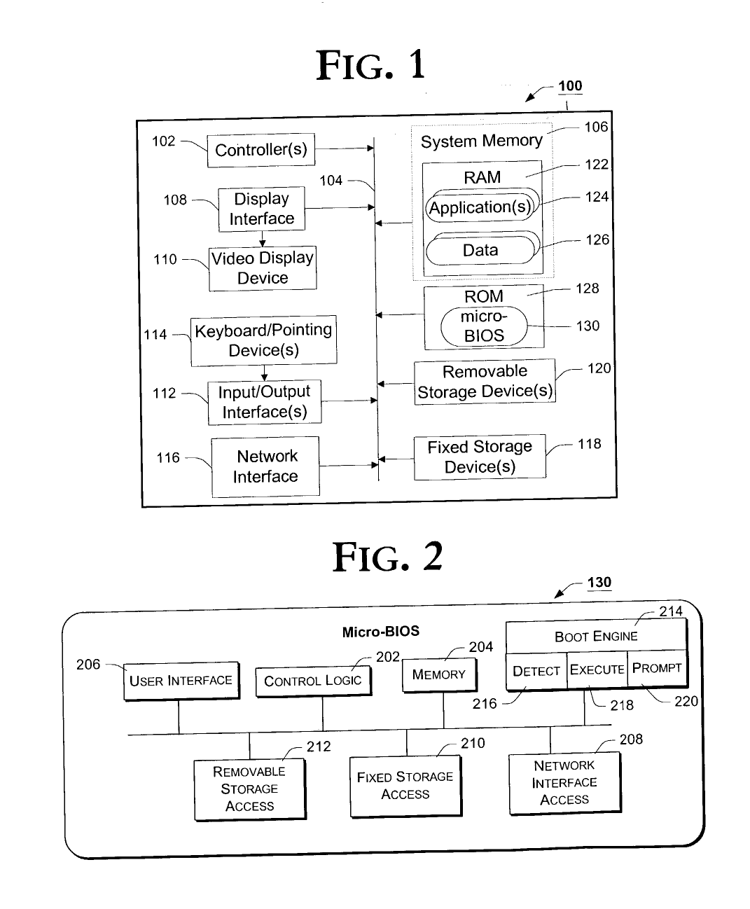

ROM 128 is typically non-volatile and has the ability to retain its contents while using little or no power. In one embodiment, ROM 128 is a plurality of complimentary metal-oxide silicon (CMOS) memories. In an alternate embodiment, ROM 128 is a 64 kilo-bit (kb) flash memory, which costs less than a 1 mega-bit (Mb) flash memory found in other electronic appliances. In yet another embodiment, ROM 128 is a combination of CMOS and flash memories. ROM 128 is used to store micro-BIOS 130, which is a software program that enables electronic appliance 100 to function by initializing components and/or locating extended BIOS elements necessary to initialize components when electronic appliance 100 is powered on, as presented in greater detail with reference to FIG. 2. In one embodiment, micro-BIOS 130 is copied to RAM 122 when electronic appliance 100 is first powered on for quick access at any time.

Electronic appliance 100 includes display interface 108, which in turn is coupled with video display device 110, such as a cathode ray tube (CRT) or liquid crystal display (LCD), for displaying information to a computing device user. Keyboard/pointing device(s) 114, including alphanumeric and other keys and a mouse, a trackball, or cursor direction keys, are typically coupled with bus 104 via an input/output interface 112 for communicating information, command selections, and cursor movement to controller 102.

Electronic appliance 100 further includes network interface 116 that provides access to a network (not shown in FIG. 1). In one embodiment, network interface 116 is a network interface card (NIC); however, other network interfaces can also be used.

Bus 104 can be a single bus or a plurality of busses that provide interconnection to the components of electronic appliance 100. In one embodiment bus 104 includes separate busses exclusively for memory access and display access.

Fixed storage device(s) 118, which typically are magnetic media drives, cost much less per Mb than flash memory, and provide relatively large amounts of storage for applications and data. In one embodiment, fixed storage device(s) 118 comprises a hard drive with partitions compliant with the Protected Area Run Time Interface Extension Services (PARTIES) Standard available from the American National Standards Institute (ANSI) as document ANSI INCITS 346-2001.

Removable storage device(s) 120, such as a floppy disk drive (a magnetic media drive) or CD-ROM drive (an optical media drive), provide high capacity storage of applications and data that may be needed by controller 102. The media used for storage can be easily removed and replaced from the drive by the user.

FIG. 2 is a block diagram of an example micro-BIOS architecture, in accordance with one example embodiment of the invention. As shown, micro-BIOS 130 includes one or more of control logic 202, memory 204, user interface 206, network interface access 208, fixed storage access 210, removable storage access 212, and boot engine 214 coupled as shown in FIG. 2. In accordance with one aspect of the present invention, to be developed more fully below, micro-BIOS 130 includes a boot engine 214 comprising one or more of detection services 216, execution services 218, and/or prompting services 220. It is to be appreciated that, although depicted as a number of disparate functional blocks, one or more of elements 202-220 may well be combined into one or more multi-functional blocks. Similarly, boot engine 214 may well be practiced with fewer functional blocks, i.e., with only prompting services 220, without deviating from the spirit and scope of the present invention. In this regard, micro-BIOS 130 in general, and boot engine 214 in particular, are merely illustrative of one example implementation of one aspect of the present invention.

As introduced above, micro-BIOS 130 initializes components and/or locates extended BIOS elements necessary to initialize components when electronic appliance 100 is powered on. In one embodiment, micro-BIOS 130 performs some of the functions of a conventional BIOS, such as initializing system memory 106, and then locates extended BIOS elements to perform the remaining functions of a conventional BIOS. In an alternate embodiment, micro-BIOS 130 operates as described in reference to the previous embodiment and also locates extended BIOS elements that perform the functions of option ROM's that are stored remotely from the peripheral devices with which they are associated.

As used herein control logic 202 provides the logical interface between micro-BIOS 130 and electronic appliance 100. In this regard, control logic 202 manages one or more aspects of micro-BIOS 130 to provide a communication interface from electronic appliance 100 to extended BIOS elements resident thereon. According to one aspect of the present invention, control logic 202 receives initialization event indications such as, e.g., an interrupt, from bus 104 indicating a power-on event. Upon receiving such an indication, control logic 202 selectively invokes the resource(s) of boot engine 214. As part of an example boot method, as explained in greater detail with reference to FIG. 5, control logic 202 selectively invokes detection services 216 and execution services 218 that locate and cause to be executed, respectively, extended BIOS elements. Control logic 202 also selectively invokes prompting services 220, as explained in greater detail with reference to FIG. 5, to prompt a user to provide access to extended BIOS elements. As used herein, control logic 202 is intended to represent any of a wide variety of control logic known in the art and, as such, may well be implemented as a microprocessor, a micro-controller, a field-programmable gate array (FPGA), application specific integrated circuit (ASIC), programmable logic device (PLD) and the like. Control logic 202 may also be implemented as controller(s) 102. In alternate implementations, control logic 202 is intended to represent content (e.g., software instructions, etc.), which when executed implements the features of control logic 202 described herein.

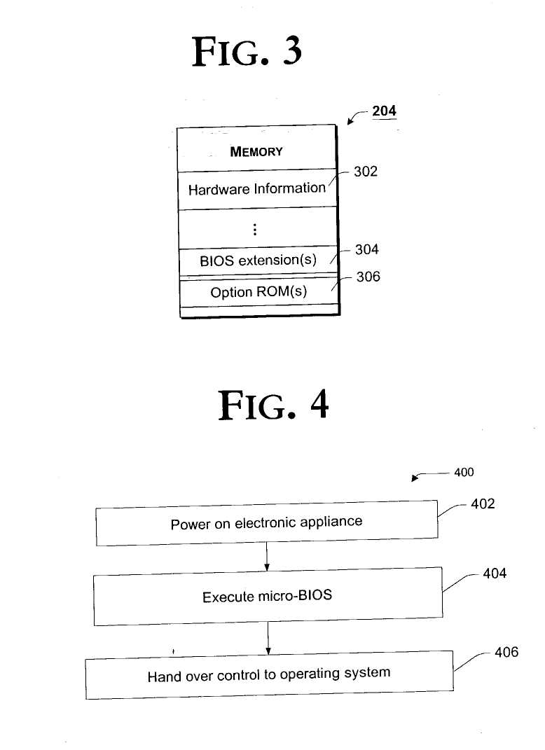

Memory 204 is intended to represent any of a wide variety of memory devices and/or systems known in the art. According to one example implementation, memory 204 may well include volatile and non-volatile memory elements, possibly RAM 122 and/or ROM 128. In accordance with one aspect of the present invention, memory 204 includes non-volatile memory element(s) used to maintain initialization information. According to one example implementation, the non-volatile memory elements are comprised of electronically erasable programmable read-only memory (EEPROM) element(s) (not specifically denoted). A graphical illustration of an example memory 204 is presented with reference to FIG. 3.

User interface 206 allows control logic 202 to gain access to video display device 110 as part of prompting services 220 to convey a message prompting a user to provide access to extended BIOS elements.

Network interface access 208 provides a path through which control logic 202 can detect extended BIOS elements through network interface 116 and across a communication network, as part of detection services 216.

Fixed storage access 210 and removable storage access 212 provide a conduit for control logic 202 to detect extended BIOS elements stored on fixed storage device(s) 118 and removable storage device(s) 120, respectively, as part of detection services 216.

As introduced above, boot engine 214 is selectively invoked by control logic 202 to locate and cause to be executed remote extended BIOS elements. In accordance with the illustrated example implementation of FIG. 2, boot engine 214 is depicted comprising one or more of detection services 216, execution services 218 and prompting services 220. Although depicted as a number of disparate elements, those skilled in the art will appreciate that one or more elements 216-220 of boot engine 214 may well be combined without deviating from the scope and spirit of the present invention.

Detection services 216, as introduced above, provide micro-BIOS 130 with the ability to detect the presence of extended BIOS elements stored on remote storage devices, such as fixed storage device(s) 118, removable storage device(s) 120, and storage devices communicatively coupled to network interface 116. In one example embodiment, detection services 216 looks for a certain predetermined string of characters at the start of fixed boundaries in each storage device to identify the presence of extended BIOS elements. In an alternate embodiment, detection services 216 searches for extended BIOS elements on a partition of a hard drive, such as a PARTIES partition, that is not visible to the operating system.

As introduced above, execution services 218 provide micro-BIOS 130 with the ability to cause the extended BIOS elements that are located by detection services 216 to be executed. In one example embodiment, execution services 218 causes the extended BIOS elements to be copied to system memory 106 and executed by controller(s) 102.

Prompting services 220, as introduced above, provide micro-BIOS 130 with the ability to convey a message prompting a user to provide access to extended BIOS elements. In one embodiment, prompting services 220 causes a message to be displayed on video display device 110 that requests the user to insert a specific removable media, such as a CD, into a removable storage device 120, such as a CD-ROM drive. In an alternate embodiment, prompting services 220 causes a message to be displayed on video display device 110 that requests the user to enter a password on keyboard device 114 that enables access to a network communicatively coupled with network interface 116. Any extended BIOS elements to which the user has provided access would then be located by detection services 216 and caused to be executed by execution services 218.

FIG. 3 is a graphical illustration of an example data structure suitable for use in accordance with micro-BIOS 130, in accordance with one example embodiment of the invention. Memory 204 stores hardware information 302, BIOS extension(s) 304, and option ROM(s) 306.

As used herein, hardware information 302 may include information such as memory addresses, or pointers to other memory address where information may be found to be able to communicate with the various components of electronic appliance 100. In one embodiment, micro-BIOS 130 matches hardware with the associated option ROM(s). In an alternate embodiment, option ROM's include content to detect the associated hardware, independent of micro-BIOS 130.

BIOS extension(s) 304 and option ROM(s) 306 stored in memory 204 may provide information about the extended BIOS elements that have been located by detection services 216. In one embodiment, detection services 216 records the memory addresses of at least a subset of all BIOS extension(s) and option ROM(s) located. Execution services 218 then uses these memory addresses to copy the BIOS extension(s) and option ROM(s) to system memory 106 and causes them to be executed by controller(s) 102.

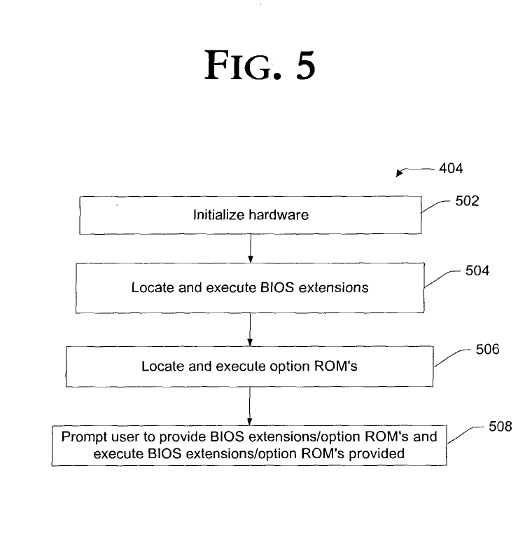

FIG. 4 is a flow chart of an example method for booting an electronic appliance, in accordance with one example embodiment of the invention. The method begins with a power on (402) of the electronic appliance 100. In one embodiment, a user performs the power-on by pushing a power button on the electronic appliance 100. In an alternate embodiment, a device communicatively coupled with network interface 116 performs the power-on by sending a signal to electronic appliance 100.

Next, micro-BIOS 130 is executed (404) as presented in greater detail with reference to FIG. 5. Finally, control of electronic appliance 100 is handed over (406) to an operating system which loads and provides the user with an interface to interact with electronic appliance 100.

FIG. 5 is flow chart of an example method for implementing a micro-BIOS, in accordance with one example embodiment of the invention. The method begins with initializing (502) of hardware. In one embodiment, only system memory 106 is initialized to the extent necessary to allow detection services 216, execution services 218, and/or prompting services 220 to function properly. In an alternate embodiment, components of electronic appliance 100 that may contain extended BIOS elements, i.e. fixed storage device(s) 118, are also initialized at this point at least to the extent necessary for detection services 216 to be able to locate the extended BIOS elements thereon.

Next, detection services 216 and execution services 218 locate (504) and cause to be executed any BIOS extensions that are accessible to electronic appliance 100. In one embodiment, detection services 216 searches for BIOS extensions in a predetermined pattern by first searching removable storage device(s) 120, and then searching fixed storage device(s) 118, and then searching storage devices communicatively coupled with network interface 116.

Detection services 216 and execution services 218 then locate (506) and cause to be executed any option ROM's that are accessible to electronic appliance 100. The means of locating and executing option ROM's may be the same or different than the means of locating and executing BIOS extensions. In one embodiment, a component of electronic appliance 100, i.e. display interface 108, may have a subset or none of its associated option ROM stored on a flash memory device on display interface 108 and the remainder stored remotely on fixed storage device(s) 118, for example. In this case, detection services 216 would detect the option ROM stored remotely from display interface 108. Also in the same embodiment, execution services 218 would cause the option ROM associated with display interface 108 to be executed either separately or after being combined with a subset of the option ROM that was not stored remotely.

Lastly, prompting services 220 prompts (508) a user to provide extended BIOS elements that, if provided, are located by detection services 216 and caused to be executed by execution services 218. In one embodiment, as introduced above, prompting services 220 causes a message to be displayed on video display device 110 that requests the user to insert a specific removable media, such as a CD, into a removable storage device 120, such as a CD-ROM drive. In an alternate embodiment, prompting services 220 causes a message to be displayed on video display device 110 that requests the user to enter a password on keyboard device 114 that enables access to a storage device communicatively coupled with network interface 116. In one embodiment, prompting services 220 may only be executed if no extended BIOS elements or option ROM's are detected by detection services 216.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A method of booting an electronic appliance, the method comprising:
executing a micro-BIOS (Basic Input/Output System) in response to receipt of an indication associated with an initialization event;
identifying one or more remote locations of extended BIOS elements to execute in booting the electronic appliance; and
executing the extended BIOS elements to boot the electronic appliance.

2. The method of claim 1, wherein identifying remote locations comprises:
communicating with one or more of an optical drive, a magnetic media drive, and a network interface card, to determine the presence of extended BIOS elements to execute in booting the electronic appliance.

3. The method of claim 1, wherein executing extended BIOS elements from a remote location comprises initializing devices located at a different remote location.

4. The method of claim 3, wherein identifying remote locations comprises:
searching a hidden partition of a magnetic media drive for extended BIOS elements to execute in booting the electronic appliance.

5. The method of claim 4, wherein searching a hidden partition of the magnetic media drive comprises searching a PARTIES (Protected Area Run Time Interface Extension Services) partition.

6. An electronic appliance, comprising:
control logic to execute a micro-BIOS (Basic Input/Output System) and extended BIOS elements;
the micro-BIOS to identify and access the extended BIOS elements to boot the electronic appliance; and
one or more of an optical media drive, a magnetic media drive, and a network interface controller, to provide access to the extended BIOS elements to boot the electronic appliance.

7. The electronic appliance of claim 6, wherein the micro-BIOS comprises a 64 kb (kilobit) flash memory device.

8. The electronic appliance of claim 6, wherein the magnetic media drive comprises a hard drive PARTIES partition to store the extended BIOS elements to boot the electronic appliance.

9. The electronic appliance of claim 8, wherein the micro-BIOS comprises a 64 kb flash memory device.

10. The electronic appliance of claim 6, further comprising a user interface to prompt a user to provide the extended BIOS elements.

11. A storage medium comprising content which, when executed by an accessing machine, implements a micro-BIOS (Basic Input/Output System) in the accessing machine, the micro-BIOS, independent of a functional operating system executing on the accessing machine, to locate remote storage medium comprising content which, when executed by the accessing machine causes the accessing machine to boot.

12. The storage medium of claim 11, wherein the content to locate remote storage medium comprises content which, when executed by the accessing machine, causes the accessing machine to search one or more of: fixed storage device(s), removable storage device(s), and network interface(s).

13. The storage medium of claim 12, wherein content to locate remote storage medium comprises content which, when executed by the accessing machine, causes the accessing machine to prompt a user to provide access to the remote storage medium.

14. The storage medium of claim 13, wherein the content is automatically accessed by the accessing machine after a power-on event.

15. The storage medium of claim 11, further comprising content which, when executed by the accessing machine, causes the accessing machine to load an operating system.
